(19) United States
(12) Patent Application Publication
(10) Pub. No.: US 2016/0307255 A1
(43) Pub. Date: Oct. 20, 2016

(54) RECOMMENDING METHOD, INFORMATION PROCESSING APPARATUS, AND STORAGE MEDIUM

(71) Applicant: FUJI XEROX CO., LTD., Tokyo (JP)

(72) Inventors: Hidetaka IZUMO, Kanagawa (JP); Masahiro SATO, Kanagawa (JP); Takashi SONODA, Kanagawa (JP)

(73) Assignee: FUJI XEROX CO., LTD., Tokyo (JP)

(21) Appl. No.: 14/879,244

(22) Filed: Oct. 9, 2015

(30) Foreign Application Priority Data
Apr. 17, 2015 (JP) 2015-085268

(51) Int. Cl. G06Q 30/06

(52) U.S. Cl. CPC G06Q 30/0631

(57) ABSTRACT

A non-transitory computer readable medium storing a program causing a computer to execute a process for recommendation is provided. The process includes, on the basis of layer information in which dealing objects are classified into items in plural layers, calculating a value indicative of a variation in information for each of the layers from information obtained by dividing information of a dealing history of a user into the items included in the layers; and recommending a dealing object to the user on the basis of the calculated value indicative of the variation in the information of each of the layers.

### CROSS-REFERENCE TO RELATED APPLICATIONS

This application is based on and claims priority under 35 USC 119 from Japanese Patent Application No. 2015-085268 filed Apr. 17, 2015.

### BACKGROUND

The present invention relates to a recommending method, an information processing apparatus, and a storage medium.

### SUMMARY

According to an aspect of the invention, there is provided a non-transitory computer readable medium storing a program causing a computer to execute a process for recommendation, the process including, on the basis of layer information in which dealing objects are classified into items in plural layers, calculating a value indicative of a variation in information for each of the layers from information obtained by dividing information of a dealing history of a user into the items included in the layers; and recommending a dealing object to the user on the basis of the calculated value indicative of the variation in the information of each of the layers.

### BRIEF DESCRIPTION OF THE DRAWINGS

Exemplary embodiments of the present invention will be described in detail based on the following figures, wherein:

FIG. 1 is a block diagram showing a configuration example of an information processing apparatus according to an exemplary embodiment;

FIG. 2 is a schematic illustration showing a configuration example of purchase/browsing history information;

FIG. 3 is a schematic illustration showing a configuration example of product layer information;

FIGS. 4A and 4B are illustrations for explaining an example of a modeling operation;

FIGS. 5A and 5B are illustrations for explaining another example of a modeling operation;

FIGS. 6A and 6B are illustrations for explaining still another example of a modeling operation; and

FIG. 7 is a flowchart showing an operation example of the information processing apparatus.

### DETAILED DESCRIPTION

### Exemplary Embodiment

### Configuration of Information Processing Apparatus

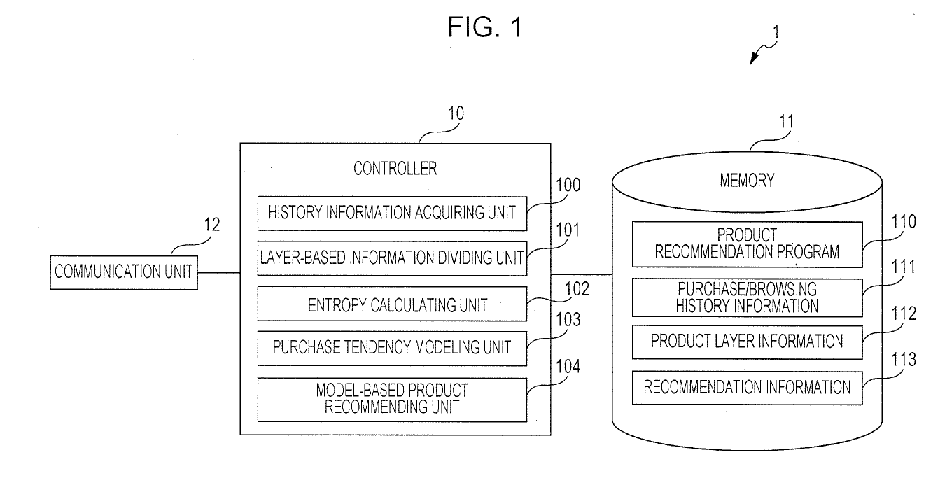

FIG. 1 is a block diagram showing a configuration example of an information processing apparatus according to an exemplary embodiment.

An information processing apparatus 1 is configured of a central processing unit (CPU) etc. The information processing apparatus 1 includes a controller 10 that controls respective units and executes various programs, a memory 11 that is configured of a storage medium such as a flash memory and stores information, and a communication unit 12 that makes communication with an external device through a network.

The controller 10 executes a product recommendation program 110 (described later) and hence functions as, for example, a history information acquiring unit 100, a layer-based information dividing unit 101, an entropy calculating unit 102, a purchase tendency modeling unit 103, and a model-based product recommending unit 104.

For example, in electronic commerce in which a product or a service is sold, purchased, or distributed through electronic information communication in a computer network, the history information acquiring unit 100 acquires purchase/browsing history information 111 being a history indicating dealing (browsing or purchasing of a product) by a user in the past, from a service provider that provides a service for the electronic commerce. It is assumed that a dealing object includes a tangible object and an intangible object, and dealing includes, for example, purchasing, downloading, and renting. Hereinafter, a movie rental service is described as an example of a service. A dealing object is a movie, and dealing is renting and downloading.

The layer-based information dividing unit 101 divides the purchase/browsing history information 111 for each of the layers on the basis of product layer information 112 being information in which categories of products are classified into layers. For example, if a layer includes plural items indicative of genres of movies, such as action, SF, and comedy, the purchase/browsing history information 111 in this layer is divided into items.

The entropy calculating unit 102 calculates information entropy as a value indicative of a variation in information of the information divided by the layer-based information dividing unit 101. The information entropy may be calculated for all layers, or for part of the layers under a predetermined rule.

The purchase tendency modeling unit 103 models the purchase/browsing history information 111 on the basis of the information entropy calculated for each of the layers. A specific example of the modeling is described later in “Operation of Information Processing Apparatus.”

The model-based product recommending unit 104 generates recommendation information 113 being information of a product that should be recommended to the user on the basis of a purchase tendency, which is a result of the modeling by the purchase tendency modeling unit 103.

The memory 11 stores the product recommendation program 110, the purchase/browsing history information 111, the product layer information 112, the recommendation information 113, etc. that cause the controller 10 to operate as the above-described respective units 100 to 104.

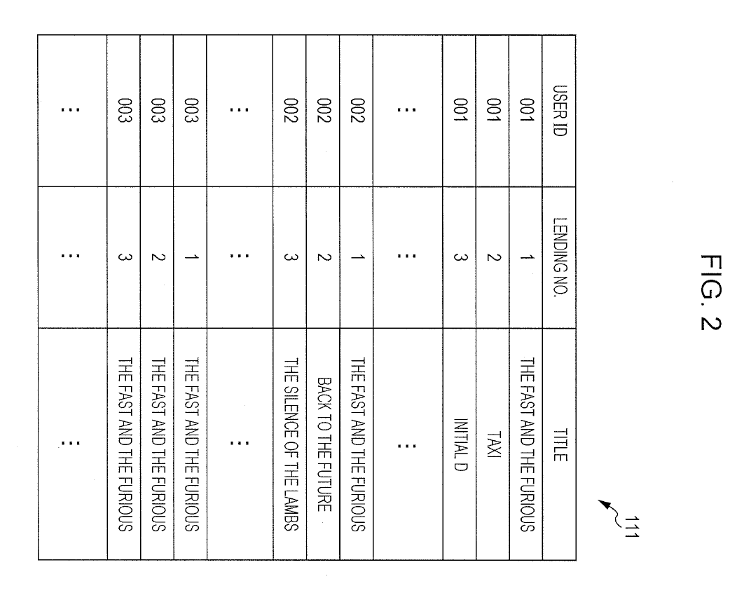

FIG. 2 is a schematic illustration showing a configuration example of the purchase/browsing history information 111.

The purchase/browsing history information 111 includes a user ID indicative of an identifier of a user who purchased a product, a lending number (lending No.) indicative of the lending out order of movies, and a title of a rented (purchased) movie (product). Further, the purchase/browsing history information 111 may include a time at which a product is rented.

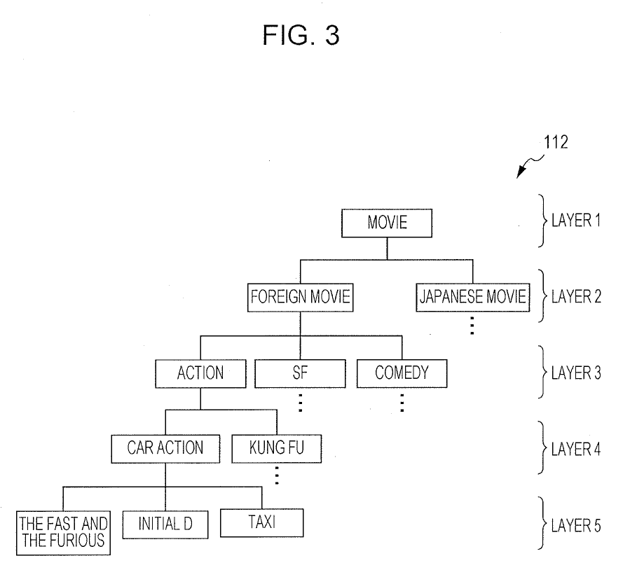

FIG. 3 is a schematic illustration showing a configuration example of the product layer information 112.

The product layer information 112 is information in which categories of movies as an example of products are classified into layers. The product layer information 112 includes a layer 1 indicative of “movie,” a layer 2 indicative of “foreign movie” and “Japanese movie” being items obtained by classifying the movie, a layer 3 indicative of “action,” “SF,” and “comedy” being items obtained by classifying the foreign movie, a layer 4 indicative of “car action” and “kung fu” being items obtained by classifying the action, and a layer 5 indicative of “the Fast and the Furious,” “Initial D,” and “TAXi” being items obtained by classifying the car action.

### Operation of Information Processing Apparatus

Next, an operation of this exemplary embodiment is described with sections of (1) basic operation and (2) modeling and recommending operation.

### (1) Basic Operation

First, a user makes an access to a web page by using a terminal apparatus such as a personal computer (PC) owned by the user. The web page is managed by a server of a service provider of electronic commerce. Then, the user browses a list of desirable movies (products). The terminal apparatus processes information transmitted from the server, and hence the web page is displayed on a display of the terminal apparatus.

The web page includes, for example, a menu display having an input box for searching a movie and a select button for selecting a movie category; thumbnail images of movies; a product information display having a name, a price, and various buttons for renting; and a product recommendation information display for displaying information relating to a movie that is recommended to the user who browses the description of the movie displayed in the product information display.

The server of the service provider records the movie that is displayed in the product information display by the user, as browsing history information, and records the rented movie as purchase history information.

Also, the server of the service provider transmits the purchase/browsing history information to the information processing apparatus 1 to request the information processing apparatus 1 for information of the movie that should be displayed in the product recommendation information display.

The information processing apparatus 1 receives the purchase/browsing history information and stores the purchase/browsing history information as the purchase/browsing history information 111 in the memory 11.

### (2) Modeling and Recommending Operation

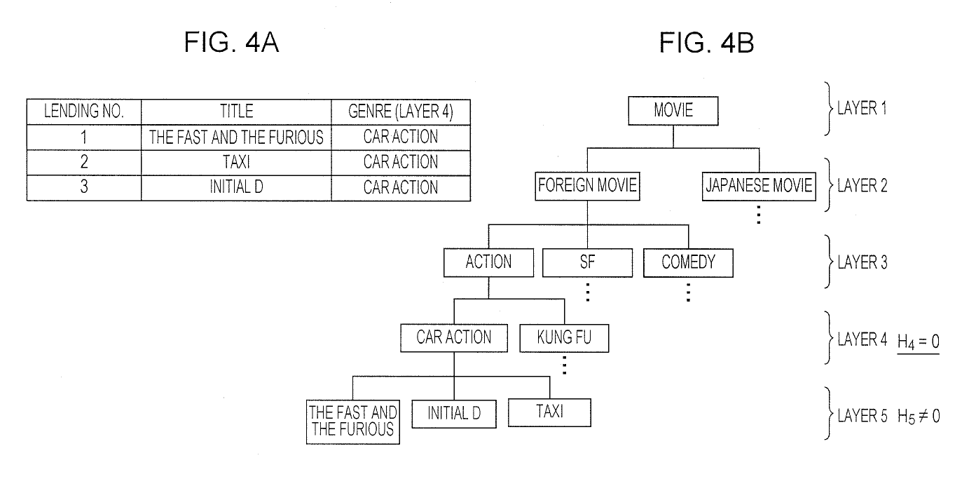

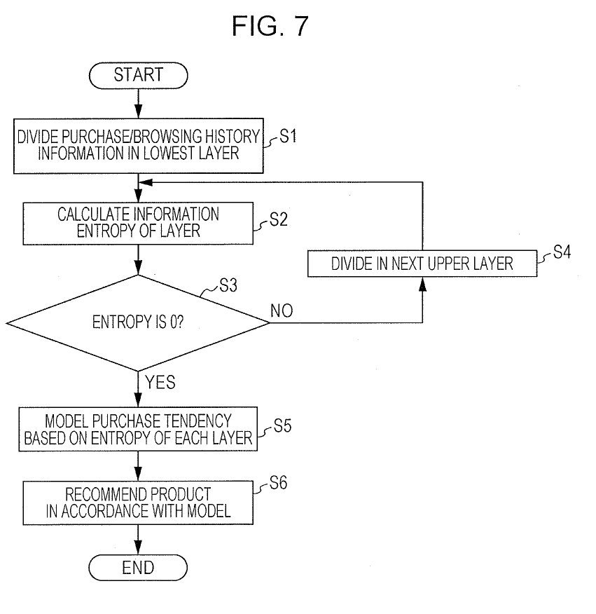

FIG. 7 is a flowchart showing an operation example of the information processing apparatus. FIGS. 4A and 4B are illustrations for explaining an example of a modeling operation.

### (2-1) Case of User “001”

First, for example, the history information acquiring unit 100 acquires history information of a user ID “001” from the purchase/browsing history information 111 shown in FIG. 2.

Then, the layer-based information dividing unit 101 divides the history information into items in the lowest layer of the product layer information 112 (S1). Since the lowest layer corresponds to titles of movies, “the Fast and the Furious,” “TAXi,” and “Initial D” are divided as titles belonging to respectively different items.

Then, the entropy calculating unit 102 calculates information entropy of the information in the layer 5 divided by the layer-based information dividing unit 101 (S2). The information entropy is calculated by Expression 1 as follows;

H=−Σᵢ₌₁^{N}pᵢ log pᵢ Expression 1,

where pᵢ denotes a probability of that a product is purchased.

In the above-described example, since N=3 and p₁ to p₃=⅓, the information entropy is H₅=−⅓ log ⅓−⅓ log ⅓−⅓ log ⅓≈0.48≠0 (S3: No).

Then, the layer-based information dividing unit 101 divides the history information in the layer 4 which is the next upper layer (S4). Since the layer 4 corresponds to genres of movies, as shown in FIG. 4A, “the Fast and the Furious,” “TAXi,” and “Initial D” belong to the item of “car action,” are the same information, and hence are not divided.

In this example, since N=1 and p₁=1, the information entropy is H₄=−1 log 1=0 (S3; Yes). Also in the further upper layer, the history information belongs to the same item and hence is not divided. Thus the information entropy becomes 0.

In this case, the information entropy represents the presence of preference of the user when the user selects a product. As the information entropy approaches 0, it may be found that the user selects the same item in the layer according to user's preference. Also, as the information entropy increases, it may be found that the user selects an item without preference in the layer.

Accordingly, the purchase tendency modeling unit 103 models the purchase/browsing history information 111 on the basis of the information entropy calculated for each layer. That is, in the above-described example, since the information entropy becomes 0 in the layer 4, the user tends to select “car action” and the result of the modeling is “car action” preference (S5).

Then, the model-based product recommending unit 104 recommends a movie belonging to “car action” based on the result of the modeling and having a title being different from “the Fast and the Furious,” “TAXi,” or “Initial D” (S6).

### (2-2) Case of User “002”

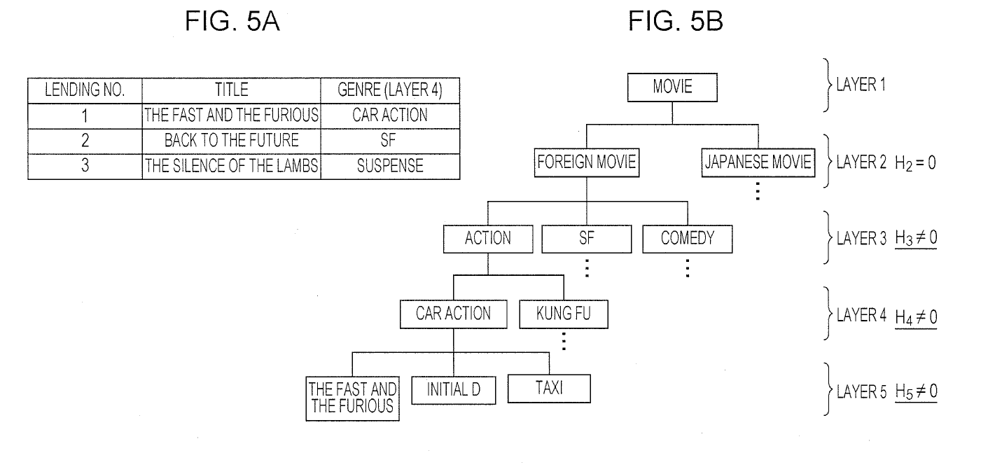

FIGS. 5A and 5B are illustrations for explaining another example of a modeling operation.

Also, as a second example, the history information acquiring unit 100 acquires history information of a user ID “002” from the purchase/browsing history information 111 shown in FIG. 2.

First, the layer-based information dividing unit 101 divides the history information into items in the lowest layer of the product layer information 112 (S1). Since the lowest layer corresponds to titles of movies, “the Fast and the Furious,” “the Back to the Future,” and “the Silence of the lambs” are divided as titles belonging to respectively different items.

Then, the entropy calculating unit 102 calculates information entropy of the information in the layer 5 divided by the layer-based information dividing unit 101 (S2). In the above-described example, since N=3 and p₁ to p₃=⅓, the information entropy is H₅=−⅓ log ⅓−⅓ log ⅓−⅓ log ⅓≈0.48≠0 (S3: No).

Then, the layer-based information dividing unit 101 divides the history information in the layer 4 which is the next upper layer (S4). Since the layer 4 corresponds to genres of movies, as shown in FIG. 5A, “the Fast and the Furious,” “the Back to the Future,” and “the Silence of the Lambs” respectively belong to the items of “car action,” “SF,” and “Suspense,” and are divided as items belonging to different items.

Therefore, also in this layer, H₄≈0.48≠0 is established (S3; No). Similarly, H₃≠0 is established, and H₂=0 is established in the layer 2.

The purchase tendency modeling unit 103 models the purchase/browsing history information 111 on the basis of the information entropy calculated for each layer. That is, in the above-described example, since the information entropy in any one of the layers 3 to 5 is not 0, it may be found that the interest of the user is not biased to a specific genre although the user selects only foreign movies.

Then, the model-based product recommending unit 104 recommends a movie by using an existing method such as collaborative filtering from movies belonging to “foreign movie” on the basis of the result of the modeling, or recommends a hot-selling movie or a popular movie (S6). Also, even when the information entropy is not 0, if the layer having smaller information entropy than the other layer is present, a movie may be recommended by using an existing method in that layer.

### (2-3) Case of User “003”

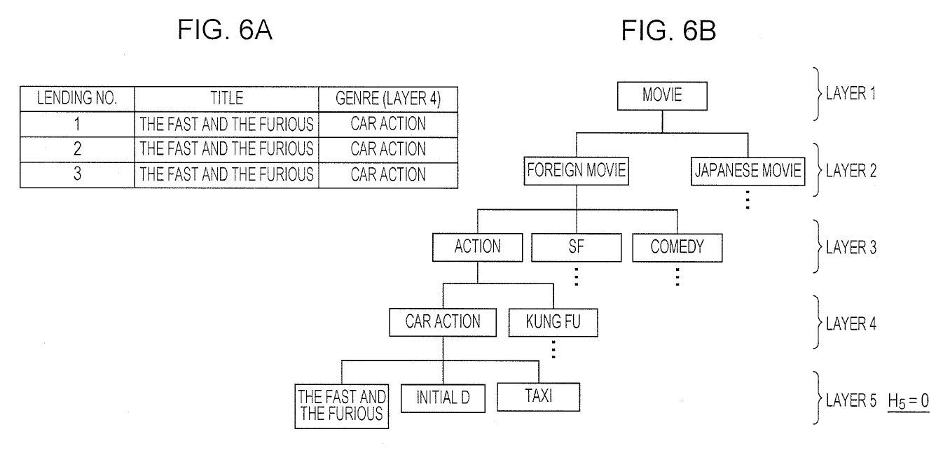

FIGS. 6A and 6B are illustrations for explaining still another example of a modeling operation.

Also, as a third example, the history information acquiring unit 100 acquires history information of a user ID “003” from the purchase/browsing history information 111 shown in FIG. 2.

First, the layer-based information dividing unit 101 divides the history information into items in the lowest layer of the product layer information 112 (S1). Since the lowest layer corresponds to titles of movies, “the Fast and the Furious” is assumed to belong to the same item and hence is not divided.

Then, the entropy calculating unit 102 calculates information entropy of the information in the layer 5 divided by the layer-based information dividing unit 101 (S2). In the above-described example, since N=1 and p₁=1, the information entropy is H₅=0 (S3; Yes).

The purchase tendency modeling unit 103 models the purchase/browsing history information 111 on the basis of the information entropy calculated for each layer. That is, in the above-described example, since the information entropy is 0 in any one of the layers 1 to 5, it may be found that the interest is markedly biased.

Then, the model-based product recommending unit 104 repetitively recommends the movie with the title of “the Fast and the Furious” on the basis of the result of the modeling (S6).

### Effects of Exemplary Embodiment

With the above-described exemplary embodiment, the purchase/browsing history information 111 of the user is divided into items in respective layers for each of the layers of the product layer information 112, the information entropy is calculated, and the purchase tendency of the user is grasped in the structure of the layers. Accordingly, a product may be recommended to the user without use of purchase/browsing history information of the other person.

Also, since the purchase/browsing history information of the other person is not used, a situation in which a product browsed and purchased by the other person whose purchase tendency is similar to the purchase tendency of the user, hence products in various categories are recommended, and willingness to purchase of the user is let off like related art, does not occur.

### Other Exemplary Embodiment

The present invention is not limited to the above-described exemplary embodiment, and may be modified in various ways without departing from the scope of the invention. For example, even when a product without the product layer information 112 is handled, in the purchase/browsing history information 111, the layer may be estimated on the basis of the product layer information 112 of a product which is purchased simultaneously with the product. For example, when a printer and an ink are purchased simultaneously and layer information of the ink is not present, the layer is estimated from the layer information of the printer.

Also, in the above-described exemplary embodiment, the information entropy is calculated. However, it is not limited thereto as long as a value indicative of a variation in information is used. For example, as a dealing history, information, such as a browsing time of a web page of a product or a moving distance of a cursor in the web page is recorded, and a difference (deviation) with respect to the average of the information of the other users is calculated as a value indicative of a variation in information. The value indicative of the variation is calculated for each layer, and an item in a layer with a large value indicative of the variation may be recommended to the user.

In the above-described exemplary embodiment, the functions of the respective units 100 to 104 of the controller 10 are realized by the programs. However, all the functions or part of the functions may be realized by hardware such as an application specific integrated circuit (ASIC). Also, the programs used in the above-described exemplary embodiment may be stored in a storage medium such as a compact disc read only memory (CD-ROM) or the like, an may be provided. Also, the order of the steps described in the above-described exemplary embodiment may be changed, the steps may be partly deleted, and other step may be added within a range that does not change the scope of the invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process for recommendation, the process comprising:
on the basis of layer information in which dealing objects are classified into items in a plurality of layers, calculating a value indicative of a variation in information for each of the layers from information obtained by dividing information of a dealing history of a user into the items included in the layers; and
recommending a dealing object to the user on the basis of the calculated value indicative of the variation in the information of each of the layers.

2. The medium according to claim 1, the process further comprising:
modeling a tendency of dealing of the user on the basis of the calculated value indicative of the variation in the information of each of the layers,
wherein the recommending recommends a dealing object to the user on the basis of a result of the modeling.

3. The medium according to claim 1, wherein, in a plurality of dealing objects dealt simultaneously in the information of the dealing history, if a dealing object without the layer information is present, the calculating estimates layer information of the dealing object from layer information of a dealing object with the layer information and calculates the value indicative of the variation in the information.

4. The medium according to claim 1, wherein the calculating calculates information entropy or a deviation of the dealing history as the value indicative of the variation in the information.

5. An information processing apparatus comprising:
a calculating unit that, on the basis of layer information in which dealing objects are classified into items in a plurality of layers, calculates a value indicative of a variation in information for each of the layers from information obtained by dividing information of a dealing history of a user into the items included in the layers; and
a recommending unit that recommends a dealing object to the user on the basis of the calculated value indicative of the variation in the information of each of the layers calculated by the calculating unit.

6. A recommending method comprising:
on the basis of layer information in which dealing objects are classified into items in a plurality of layers, calculating a value indicative of a variation in information for each of the layers from information obtained by dividing information of a dealing history of a user into the items included in the layers; and
recommending a dealing object to the user on the basis of the calculated value indicative of the variation in the information of each of the layers.
